(19) United States
(12) Patent Application Publication
(10) Pub. No.: US 2022/0147368 A1
(43) Pub. Date: May 12, 2022

(54) CONFIGURING LOCALIZATIONS BASED ON PERIPHERAL DEVICE LOCALIZATION SETTINGS

(71) Applicant: Hewlett-Packard Development Company, L.P., Spring, TX (US)

(72) Inventors: Peter Seiler, Fort Collins, CO (US); Aaron M. Laaveg, Fort Collins, CO (US); Adolfo Gomez, Fort Collins, CO (US)

(73) Assignee: Hewlett-Packard Development Company, L.P., Spring, TX (US)

(21) Appl. No.: 17/438,033

(22) PCT Filed: Jul. 26, 2019
(86) PCT No.: PCT/US2019/043756

§ 371 Date: Sep. 10, 2021

(51) Int. Cl. G06F 9/4401; G06F 9/451; G06F 3/0482

(52) U.S. Cl. CPC G06F 9/4411; G06F 3/0482; G06F 9/454

(57) ABSTRACT

In some examples, non-transitory computer-readable medium stores machine-readable instructions that, when executed by a processor of a computing device, cause the processor to receive a localization setting associated with a peripheral device; and configure a localization of the computing device based on the localization setting.

### BACKGROUND

Computing devices allow for peripheral devices to be customized or switched out. For example, keyboards may be switched out to allow a user to input information into the computing device in a language other than the default configured language of the computing device. The language of the computing device may then be reconfigured to match the language of the keyboard.

### BRIEF DESCRIPTION OF THE DRAWINGS

Various examples will be described below referring to the following figures:

FIG. 1 is a schematic diagram of a computing device, in accordance with various examples;

FIG. 2 is a schematic diagram of a computer-readable medium with machine-readable instructions in a computing device, in accordance with various examples;

FIG. 3 is a flow diagram of an illustrative method to change a localization of a computing device, in accordance with various examples;

FIG. 4 is a flow diagram of an illustrative method to change a localization of a computing device, in accordance with various examples;

FIG. 5 is a lookup table illustrative of locale settings available on a computing device, in accordance with various examples; and

FIG. 6 is a lookup table illustrative of locale-specific language settings available on a computing device, in accordance with various examples.

### DETAILED DESCRIPTION

As explained above, computing devices allow peripheral devices to be customized or switched out to realize both practical and aesthetic purposes. For example, a user may use one language input for work purposes but a second language input for personal purposes, which often requires changing keyboards.

In another example, a software application comprises machine-readable instructions on the computing device and may need a hardware security key, such as a dongle, in order to execute. In other instances, a peripheral device, such as a wireless keyboard, may use a dongle to communicate with the computing device. However, configuring the language, as represented by the letters and symbols associated with a language or dialect of a consumer market, of the computing device to match the language of the peripheral devices may be difficult due to language translation difficulties, such as when the language of the computing device is in a language other than that of the user. In addition to language difficulties, lack of user knowledge may make configuring the localization (which may include linguistic, physical, business and cultural, and technical characteristics related to a consumer market) of the computing device to match the localization settings (which may comprise a number of indications about the linguistic, physical, business and cultural, and technical characteristics related to another consumer market) of the peripheral devices difficult.

This disclosure describes various examples of a computing device that configures its language and localization based on a localization setting of a communicatively coupled peripheral device. For instance, during a manufacturing process in the United States of America, a Korean keyboard may be communicatively coupled to a notebook and the notebook may then set its localization based on the localization setting of the Korean keyboard. This allows both the language of the notebook to be set to Korean and also any Korea-specific settings to be configured on the notebook without the need for an English-speaking user to manually select the appropriate Korean-based prompts. Enabling the computing device to detect the localization setting of a peripheral device and automatically update the localization of the computing device removes language barriers and the need for a user to understand the technicalities of localization, which includes a number of factors, not limited to: language, keyboard layout, communication frequency bands, and signal drive strengths, as well as culture-specific norms, such as idioms, symbols and ideology, and data formats, such as for numbers, date, time, and currency.

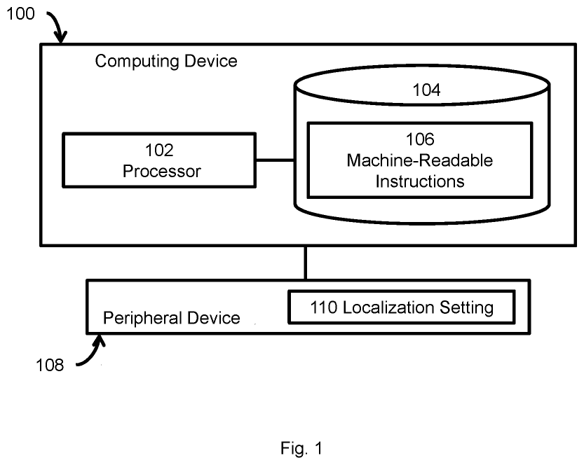

FIG. 1 is a schematic diagram of a computing device 100, in accordance with various examples. The computing device 100 comprises a processor 102, a computer-readable medium 104 storing machine-readable instructions 106, and a peripheral device 108. The computing device 100 may be a laptop computer, desktop computer, notebook computer, server, workstation, mobile phone, or tablet. The processor 102 may comprise a microprocessor, a microcomputer, or a microcontroller. The computer-readable medium 104 may include a hard drive, solid state drive (SSD), flash memory, or random access memory (RAM). The peripheral device 108 may be coupled to the computing device 100. The peripheral device 108 may be an input device, such as a keyboard or a dongle. The peripheral device 108 may include a localization setting 110.

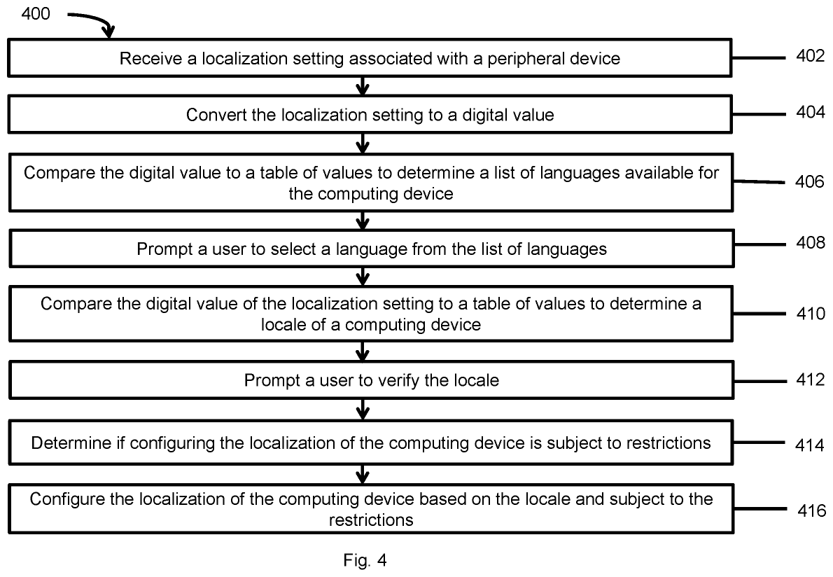

In various examples, the localization setting 110 may include an indication of a language associated with the peripheral device 108. For example, the peripheral device 108 may be a keyboard. The keyboard may be a single language keyboard, such as English (American) or a multiple-language keyboard, such as Russian/English. In various examples, the localization setting 110 of a multiple-language keyboard may include an indication of a default language associated with the keyboard. In some examples, the language associated with the keyboard may be determined by comparing the indication of the localization setting to a lookup table, as explained in greater detail below with regard to FIGS. 4, 5, and 6.

In operation, the processor 102 of computing device 100 may receive a localization setting 110 of the peripheral device 108. The localization setting 110 may indicate various types of information, such as the location, regulatory certifications, communication frequency bands, and signal strengths of the consumer market of the peripheral device. In this disclosure, each such type of information is called an “indication” of the localization setting. Any of a variety of types of information qualifies as localization indications with the potential exception of language, which in some examples may be excluded. The processor 102 may configure a localization of the computing device 100 based on the localization setting 110. The configuration of the localization of the computing device 100 may include, for example, adjusting the time and date settings, updating the regulatory certifications, or re-configuring communication bands and signal strengths based on the location. In some examples, localization indications may not include language, and so the configuration of the localization of the computing device 100 does not necessarily include the implementation of a particular language.

In some examples, after communicatively coupling the keyboard to the computing device 100, the machine-readable instructions 106 may instruct the processor 102 to prompt a user to verify the language of the keyboard. In some instances, if the keyboard is a multiple-language keyboard, the machine-readable instructions 106 may instruct the processor 102 to provide a list of languages supported by the keyboard so that the user may select the language of the keyboard. Additionally, the user prompt may be in a language associated with the keyboard.

In other examples, the machine-readable instructions 106 may instruct the processor 102 to interpret inputs received from the keyboard in accordance with the localization setting 110. For example, the machine-readable instructions 106 may instruct the processor 102 to interpret keystrokes on the keyboard in accordance with a keyboard configuration associated with the localization setting 110. The keyboard configuration provides a mapping of which characters are located on each key of the keyboard. For instance, if the keyboard is an English (American) keyboard, the indication of the localization setting 110 may provide that the “3” key corresponds to the “#” symbol. In contrast, if the keyboard is an English (UK) keyboard, the indication of the localization setting 110 may provide that the “3” key corresponds to the symbol for the British pound sterling.

In some examples, the machine-readable instructions 106 may instruct the processor 102 to change the output language of the computing device 100 in accordance with the localization setting 110. For example, the machine-readable instructions 106 may instruct the processor 102 to display characters on a monitor communicatively coupled to the computing device 100 in accordance with a language of the keyboard. For instance, if the language of the keyboard is English (American), “color” may be displayed. In contrast, if the language of the keyboard is English (UK), “colour” may be displayed.

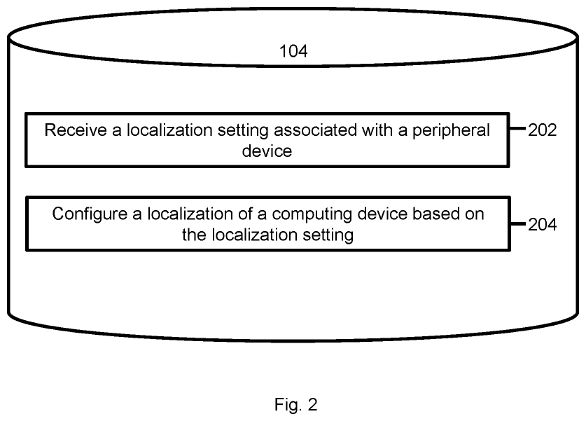

FIG. 2 is a schematic diagram of the computer-readable medium 104 with machine-readable instructions 202, 204 to set a localization for the computing device 100, in accordance with various examples. The instructions 202, 204 may be machine-readable instructions for execution by processor 102 and are illustrative of machine-readable instructions 106. Execution of instruction 202 may cause the processor 102 to receive the localization setting 110 from the peripheral device 108. Execution of instruction 204 may cause the processor 102 to configure the localization of the computing device 100 based on the localization setting 110. As explained above, the configuration of the localization of the computing device 100 may include, for example, adjusting the time and date settings, updating the regulatory certifications, or re-configuring communication bands and signal strengths based on the location. In some examples, language may be included as part of the configuration of the localization, but in other examples, it is specifically excluded.

In various examples, the localization setting 110 may be received via a wired connection to the computing device 100, such as universal serial bus (USB), personal system/2 port (PS/2), inter-integrated circuit (I2C), serial peripheral interface (SPI) or system management bus (SMB), or wireless connection, such as Wi-Fi or Bluetooth. In some instances, the localization setting 110 may be received through radio-frequency identification (RFID), pulse width modulation (PWM), or pulse duration modulation (PDM). In some examples, the localization setting 110 may be received from a controller or memory device of the peripheral device 108. In other examples, the localization setting 110 may be received as an electrical strap value or a multi-level strap value. The machine-readable instructions 106 may instruct the processor 102 to convert the localization setting 110 to a digital value for comparison to a table of values, as explained in greater detail below with regard to FIGS. 4, 5, and 6.

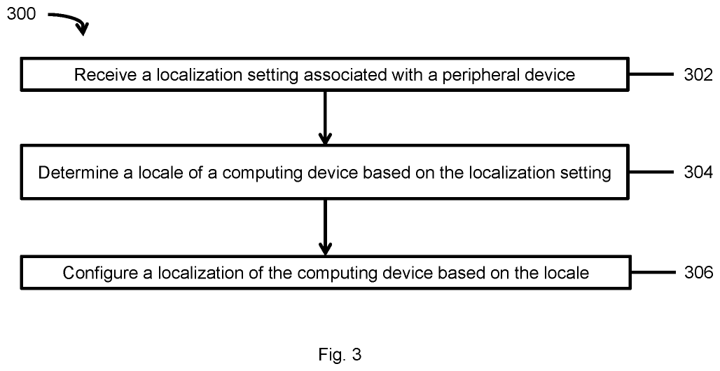

FIG. 3 is a flow diagram of an illustrative method 300 to change the localization of the computing device 100, in accordance with various examples. The method 300 may be performed, for instance, by the computing device 100. The method 300 includes receiving the localization setting 110 associated with the peripheral device 108 (302). In addition, the method 300 includes determining a locale of the computing device 100 based on the localization setting 110 (304). (A locale is a consumer market based on a geographic location such as a continent, country, region, or city.) The method 300 also includes configuring the localization of the computing device 100 based on the locale (306).

In various examples, the locale may be determined by an indication of the localization setting 110. In some examples, the locale may be determined by comparing the localization setting 110 to a lookup table, as explained in greater detail below. The locale may be associated with certain restrictions or allowances for configuring localization. For example, the peripheral device 108 may be a dongle. The dongle may include a wired connection, such as USB, PS/2, 120, SPI, or SMB, or high-definition multimedia interface (HDMI). In some examples, the dongle may enable a software application comprising machine-readable instructions to operate on the computing device 100. The localization setting 110 may include a locale associated with the software application. The computing device 100 may disable or enable certain sets of machine-readable instructions of the software application based on the locale to conform to locale-specific cultural norms.

In other examples, the localization setting 110 may include an indication for communication band frequencies. The localization setting 110 may also include an indication for signal drive strengths. For example, a dongle may enable communications with another peripheral device. The localization setting 110 may include an indication for communication band frequencies between the peripheral device and the computing device 100. The localization setting 110 may also include an indication for signal drive strengths of the communication signals between the dongle and the other peripheral device. In some instances, locale-specific restrictions may prevent the computing device 100 from re-configuring the associated localization factors, as discussed below with regards to FIG. 4.

In some examples, after the dongle is communicatively coupled to the computing device 100, the machine-readable instructions 106 may instruct the processor 102 to prompt a user to verify the language of the dongle based on the locale. In various examples, the language associated with the dongle may be determined by comparing the locale to a lookup table, as explained in greater detail below. If the dongle supports multiple languages, the machine-readable instructions 106 may instruct the processor 102 to provide the list of languages supported by the dongle so that the user may select a language. The user prompt may be in a language associated with the dongle.

In some examples, the locale may be associated with regulatory certifications. In examples where the system changes the output language of the system to a language associated with a peripheral device 108, as discussed in greater detail above with regard to FIG. 1, the method 300 may also include displaying the regulatory certifications translated to the language associated with the peripheral device 108 to an output of the system. In some instances, the translations of the regulatory certifications could be stored in memory that is part of main memory or long-term memory of the computing device 100, such as SSD, RAM, or flash memory. In other instances, machine-readable instructions could translate the regulatory certifications based on the language associated with the peripheral device 108.

FIG. 4 is a flow diagram of an illustrative method 400 to change a localization of the computing device 100, in accordance with various examples. The method 400 may be performed, for instance, by the computing device 100. The method 400 includes receiving a localization setting associated with the peripheral device 108 (402). Additionally, the method 400 may include converting the localization setting 110 to a digital value (404). Additionally, the method 400 may compare the digital value of the localization setting 110 to a table of values to determine a list of languages available for the computing device 100 (406). The method 400 may include prompting a user to select a language from the list of languages (408). In addition, the method 400 may include comparing the digital value of the localization setting 110 to a table of values to determine a locale of the computing device 100 (410). The method 400 may include prompting a user to verify the locale (412). In addition, the method 400 may determine if configuring the localization of the computing device 100 is subject to restrictions (414). The method 400 also includes configuring the localization of the computing device 100 based on the locale and subject to the restrictions, if any (416).

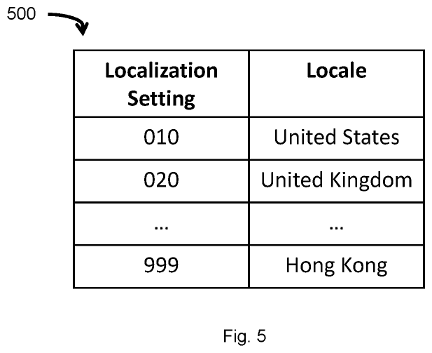

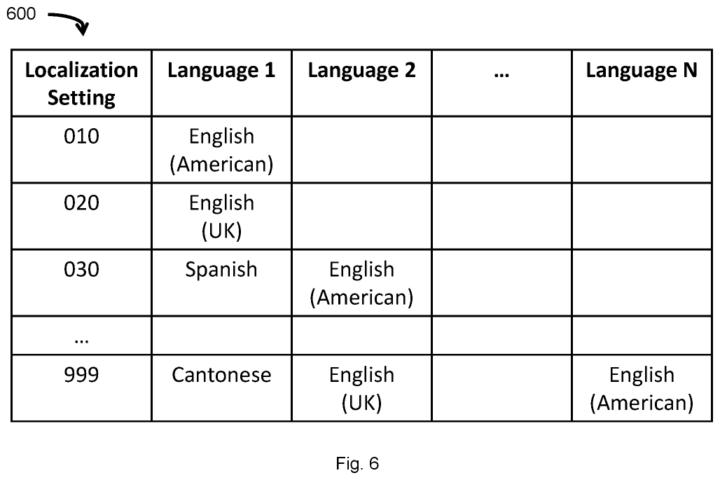

For example, during manufacturing, the method 400 may be performed to configure the localization of the computing device 100. After a keyboard is communicatively coupled to the computing device 100, the computing device 100 may receive a localization setting 110 of the keyboard. The computing device 100 may convert the localization setting 110 to a digital value. The computing device 100 may then compare the digital value to a table of values to determine a language of the computing device 100. In some instances, as further discussed below with regard to FIG. 5, the language of the computing device 100 may be associated with a specific locale. In other instances, as further discussed below with regard to FIG. 6, multiple languages may be available. The computing device 100 may then prompt the user to verify the language of the computing device 100 from a list of available languages. The computing device 100 may then compare the digital value to a table of values to determine a locale of the computing device 100. In some instances, as further discussed below with regard to FIG. 6, multiple locales may be available. The computing device 100 may then prompt a user, such as a factory technician, to verify a locale for the computing device 100 from a list of available locales. In some instances, the computing device 100 may determine if configuring the localization of the computing device 100 is subject to restrictions. For example, certain factory technicians may have permission to set the initial localization of the computing device 100. If the user has the proper permissions, the localization of the computing device 100 may be configured based on the locale selected.

In various examples, after a localization of the computing device 100 has been initially configured, re-configuration may be restricted. For example, the computing device 100 may belong to a company that provides employees with computing devices to perform work. In some instances, the company may allow employees the ability to switch out peripheral devices. However, while the company may allow the language setting of the computing device 100 to be reconfigured, changes to the localization may be prohibited. In some instances, after communicatively coupling a different keyboard, the computing device 100 performing method 400 may determine a locale of the computing device 100 but then, based on the restrictions, the computing device 100 will not configure the localization of the computing device 100 based on the locale.

In some examples, after a localization of the computing device 100 has been initially configured, reconfiguration of the localization may be partially restricted. For example, reconfiguration of the localization may be limited to certain users or certain groups of users, such as an administrator. As another example, an employee may travel with a company computing device. The new locale may support the language of the original locale but have a different localization involving certain factors, such as regulatory certifications, communication protocols, cultural sensitivities, numeric formats, date formats, time formats, and currency. The company may want to restrict the employee from re-configuring localization factors that the company uses for proprietary systems of the computing device but allow updates to the remaining factors. In some instances, after communicatively coupling the keyboard upon arrival in the new locale, the computing device may determine that configuring the localization of the computing device is restricted to certain factors. The computing device may then configure the localization as allowed, such as re-configuring the numeric formats, date formats, time formats, and currency.

FIG. 5 is a lookup table 500 illustrative of locale settings available on a computing device, in accordance with various examples. The lookup table 500 may be a data structure stored in memory that is part of main memory or long-term memory of the computing device 100, such as SSD, RAM, or flash memory. In some instances, the locale may be associated with a city, state, country, or other geographic location. For example, in the lookup table 500, the first locale is associated with the United States, the second locale is associated with the United Kingdom, and the final locale is associated with Hong Kong. Upon reading the localization setting 110, the processor 102 may use the lookup table 500 to determine the locale that corresponds to that localization setting 110. For example, if the localization setting 110 is 999 (or its digital equivalent), the processor 102 uses the lookup table 500 to determine that the corresponding locale is Hong Kong, and the processor 102 may implement localization indications as described above to correspond to Hong Kong (e.g., applying regulatory certifications corresponding to Hong Kong, using a date/time format corresponding to Hong Kong, etc.). Such locales and their corresponding localization indications may be pre-programmed into the memory (e.g., memory 104) of computing device 100.

In some cases, a table such as the lookup table 500 may not be stored in the computing device 100. Instead, a lookup table such as the lookup table 600 of FIG. 6 may be stored in the computing device 100. FIG. 6 is a lookup table 600 that cross-references localization settings with languages that correspond to those localization settings. For example, localization setting 010 may correspond to English (American), while localization setting 999 corresponds to multiple languages (Cantonese, English (UK), and English (American)). This is possible because peripheral devices 108, such as keyboards, can be multi-language devices. Upon receiving the localization setting 110, the processor 102 uses the lookup table 600 to determine the languages that correspond to that localization setting 110, and the processor 102 presents the list of languages to the user (e.g., using a display monitor). The user may select a language from the list, and upon receiving the selection, the processor 102 implements localization indications—such as those described above—based on the selected language. Thus, for instance, a localization setting of 999 causes the processor 102 to present a list including Cantonese, English (UK), and English (American) to the user. The user may select Cantonese, upon which the processor 102 determines a locale corresponding to Cantonese and implements localization indications—such as those described above—based on that locale. For instance, the selection of Cantonese by the user may prompt the processor 102 to determine that the locale of Hong Kong corresponds to Cantonese, and the processor 102 may apply localization indications corresponding to Hong Kong.

In other instances, the processor 102 may prompt the user to verify the locale, and if the user rejects the locale, the processor 102 may then present the list of locales that correspond to the selected language. Thus, for example, a localization setting of 030 causes the processor 102 to present a list including Spanish and English (American) to the user. The user may select English (American) and the processor 102 may prompt the user to verify the locale as Mexico. If the user denies verification, the processor 102 may then present a list of locales in which English (American) is an option. Upon selection, the processor 102 may apply localization indications corresponding to the user selection. In some instances, the localization may be subject to restriction, and the processor 102 may limit the list of locales to only those not subject to restriction. Locales, languages corresponding to those locales, and restrictions corresponding to those locales may be pre-programmed into the memory 104 during manufacture (e.g., in the form of a data structure).

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

1. A non-transitory computer-readable medium to store machine-readable instructions that, when executed by a processor of a computing device, cause the processor to:
receive a localization setting associated with a peripheral device; and
configure a localization of the computing device based on the localization setting.

2. The computer-readable medium of claim 1, wherein the machine-readable instructions instruct the processor to compare the localization setting associated with the peripheral device to a table of values to determine a locale of the computing device.

3. The computer-readable medium of claim 2, wherein the machine-readable instructions instruct the processor to prompt a user to select a locale from a list of locales in the table of values.

4. The computer-readable medium of claim 2, wherein the machine-readable instructions instruct the processor to compare the localization setting associated with the peripheral device to a table of values to determine a language of the computing device.

5. The computer-readable medium of claim 4, wherein the machine-readable instructions instruct the processor to prompt a user to select a language from a list of languages in the table of values.

6. The computer-readable medium of claim 4, wherein the machine-readable instructions instruct the processor to prompt a user to verify the language of the computing device.

7. The computer-readable medium of claim 1, wherein the localization of the computing device includes a setting for communication frequency bands.

8. The computer-readable medium of claim 1, wherein the localization of the computing device includes a setting for signal drive strengths.

9. The computer-readable medium of claim 1, wherein the peripheral device is a keyboard.

10. The computer-readable medium of claim 1, wherein the peripheral device is a dongle.

11. A method comprising:
receiving a localization setting associated with a peripheral device;
determining a locale of a computing device based on the localization setting; and
configuring a localization of the computing device based on the locale.

12. The method of claim 11 comprising prompting a user to verify the locale of the computing device.

13. The method of claim 11 comprising restricting the configuration of the localization based on a restriction associated with the locale.

14. The method of claim 11 comprising determining a language of the computing device by prompting a user to select the language from a list of languages associated with the localization setting.

15. The method of claim 14 comprising presenting translated certifications based on the selected language.
